(19) United States
(12) Patent Application Publication
(10) Pub. No.: US 2024/0276978 A1
(43) Pub. Date: Aug. 22, 2024

(54) Method for Dispersing Live Predatory Mites of the Phytoseiulus Genus Which Are Used in Biocontrol

(71) Applicant: Bioline Agrosciences France, Paris (FR)

(72) Inventors: Pascal Maignet, Saint Vallier De Thiey (FR); Tony Ben Soussan, Grasse (FR)

(21) Appl. No.: 17/759,626

(22) PCT Filed: Jan. 29, 2021
(86) PCT No.: PCT/FR2021/050171

§ 371 Date: Jul. 28, 2022

(30) Foreign Application Priority Data
Jan. 31, 2020 (FR) FR2000988

(51) Int. Cl. A01N 25/04; A01N 63/16

(52) U.S. Cl. CPC A01N 25/04; A01N 63/16

(57) ABSTRACT

The present invention relates to a sprayable aqueous composition for spreading biocontrol agents, comprising live biocontrol agents from the phytoseiidae family of the genus Phytoseiulus which are homogenously dispersed in a gel prepared from one or more thickening and/or gelling agents and an aqueous solution, the thickening and/or gelling agents being non-toxic for the biocontrol agents and the gel having a dynamic viscosity at zero velocity gradient of between 1 and 30,000 mPa·s.

### RELATED APPLICATIONS

This application is a National Stage Application under 35 U.S.C. 371 of PCT application PCT/FR2021/050171 designating the United States and filed Jan. 29, 2021; which claims the benefit of FR application number 2000988 and filed Jan. 31, 2021, each of which are hereby incorporated by reference in their entireties.

The invention relates to a composition and a method for dispersing living biocontrol agents of the phytoseiidae family of the genus Phytoseiulus.

During the dispersion of predatory mites of the genus Phytoseiulus, bottles containing medium in which the mites move are conventionally used. The mites will move to the top of the packaging and this leads to a very heterogeneous distribution of the mites when they are released from the bottles.

There is therefore a need for a means for spraying living mites that are able to move in an aqueous medium onto plants or culture media as part of a biocontrol strategy.

However, the mites of the genus Phytoseiulus are known to be fragile, strictly aerial and poorly adapted to high humidity (for example of the soil).

Against all expectation, the inventors firstly observed that Phytoseiulus persimilis mites can be dispersed homogeneously and survive without reduction in their biological characteristics (longevity, fertility) for several hours in an aqueous gel of modified corn starch.

In addition, they observed that the release of these mites from the gel, which is made difficult by the sticking action of the gel during drying, is possible with a satisfactory release rate and can be facilitated by the addition of a gel degradation enzyme.

The term “satisfactory rate of release” shall mean a rate of release greater than 50%, preferably greater than 80%.

The solution proposed by the invention therefore has the following advantages:
homogeneity of the dispersion of mites and homogeneity of releases;
ease of use: survival of mites for several hours without noticeable effects on the life history traits;
accessibility on crops on which dusting is not easy: e.g. raspberry plants;
application time savings.

### SUMMARY OF THE INVENTION

A first object of the present invention relates to a sprayable aqueous composition for spreading biocontrol agents, comprising live biocontrol agents from the phytoseiidae family of the genus Phytoseiulus which are homogenously dispersed in a gel prepared from one or more thickening and/or gelling agents and an aqueous solution, said thickening and/or gelling agents being non-toxic for the biocontrol agents and said gel having a dynamic viscosity at zero velocity gradient comprised between 1 and 30,000 mPa·s.

Another object of the invention relates to a method for preparing a composition according to the invention, comprising the successive steps of:
1. dissolving one or more thickening and/or gelling agents in an aqueous base, preferably water, until a gel is formed;
2. adding biocontrol agents of the phytoseiidae family of the genus Phytoseiulus and dispersing them homogeneously in said gel;
3. optionally, adding an enzyme capable of degrading said gel at a concentration allowing the total degradation of said gel in less than 12 hours, preferably in less than 2 hours.

Another object of the invention relates to the use of a composition according to the invention in order to improve the efficiency of biological control methods.

Another object of the invention relates to a biological control method comprising a step of applying the composition according to the invention on plants.

### DETAILED DESCRIPTION

The invention relates to a sprayable aqueous composition for spreading biocontrol agents, comprising live biocontrol agents from the phytoseiidae family of the genus Phytoseiulus which are homogeneously dispersed in a gel prepared from one or more thickening and/or gelling agents and an aqueous solution, the thickening and/or gelling agents being non-toxic for the biocontrol agents and the gel having a dynamic viscosity at zero velocity gradient comprised between 1 and 30,000 mPa·s.

Said gel preferably has a dynamic viscosity at zero velocity gradient comprised between 10 and 25,000, more preferably between 2 and 5000 mPa·s, still more preferably between 60 and 4500 mPa·s, still more preferably between 80 and 150 mPa·s.

The composition according to the invention preferably makes it possible to keep at least 60%, preferably at least 70%, more preferably at least 80%, particularly preferably at least 90% of the biocontrol agents of the phytoseiidae family of the genus Phytoseiulus alive for at least 2 hours, preferably 6 hours, more preferably 12 hours.

The composition according to the invention preferably makes it possible to retain at least 60%, preferably at least 70%, more preferably at least 80%, particularly preferably at least 90% of the control longevity of the biocontrol agents of the phytoseiidae family of the genus Phytoseiulus for at least 2 hours, preferably 6 hours, more preferably 12 hours.

The “control longevity” is defined as a mortality of less than 20% at 5 days.

The composition according to the invention preferably makes it possible to retain at least 60%, preferably at least 70%, more preferably at least 80%, particularly preferably at least 90% of the control fertility of the biocontrol agents of the phytoseiidae family of the genus Phytoseiulus for at least 2 hours, preferably 6 hours, more preferably 12 hours.

The “control fertility” is defined as a fertility greater than or equal to 10 eggs/female/5 days.

The composition according to the invention, after its dispersion or spraying in drops, enables a rate of release from the gel of living biocontrol agents of the phytoseiidae family of the genus Phytoseiulus greater than 60%.

Preferably, said biocontrol agents of the phytoseiidae family of the genus Phytoseiulus are chosen from the group consisting of de Phytoseiulus persimilis, Phytoseiulus macropilis, Phytoseiulus longipes and Phytoseiulus fragariae.

### The Thickening Agents/Gelling Agents

The suitable thickening agents/gelling agents and their concentration for preparing the composition according to the invention are selected in order to satisfy the above described viscosity criteria, in order to enable a homogeneous dispersion in the composition of biocontrol agents of the phytoseiidae family of the genus Phytoseiulus and in order to be non-toxic for said biocontrol agents of the phytoseiidae family of the genus Phytoseiulus.

“Non-toxic” means less than 20% of biocontrol agents dead at the end of 12 hours.

Moreover, the thickening agents/gelling agents suitable for preparing the composition according to the invention are selected to be neither toxic for the plants of the targeted crop, nor for the consumer of said plants or by-products of said plants.

Preferably, the suitable thickening agents/gelling agents for preparing the composition according to the invention are food thickening agents/gelling agents.

More preferably, the suitable thickening agents/gelling agents for preparing the composition according to the invention are chosen from the group consisting of:
polysaccharides and saccharides.

This family includes, by way of example: alginate, modified corn starch, amylopectin, carrageenans, chitosan, dextrin, guar gum, xanthan gum, glycerol and konjac gum.
polyacrylate salts

This family includes, by way of example: Carbomer 940 (polyacrylic acid), Gel maker EMU (sodium polyacrylate).
povidone derivatives

This family includes, by way of example: PVP (Polyvinylpyrrolidone).
cellulose derivatives

This family includes, by way of example: Carboxymethylcellulose, hydroxypropylcellulose.
metal salts

This family includes, by way of example: calcium chloride, potassium chloride, aluminium sulfate.

Preferably, said thickening agents/gelling agents are used in the composition according to the invention at a concentration comprised between 0.5 and 200 g/L, preferably between 1 and 90 g/L, more preferably between 2 and 40 g/L.

Most preferably, the suitable thickening agents/gelling agents for preparing the composition according to the invention are chosen from the group consisting of polysaccharides and saccharides.

Particularly preferably, said polysaccharides and saccharides are chosen from the group consisting of modified corn starch, carrageenans, xanthan gum and konjac gum.

30 Modified corn starch is preferably used at a concentration comprised between 30 and 90 g/L, preferably at 34 g/L.

Preferably, a modified corn starch gel is used with a dynamic viscosity at zero velocity gradient comprised between 60 and 25,100 mPa·s, preferably 80 mPa·s.

Preferably, carrageenans are used at a concentration comprised between 1 and 10 g/L, preferably 3 g/L.

Preferably, a carrageenan gel is used with a dynamic viscosity at zero velocity gradient comprised between 1 and 4900 mPa·s, preferably 2 mPa·s.

Preferably, xanthan gum is used at a concentration comprised between 0.5 and 5 g/L, preferably 2 g/L.

Preferably, a xanthan gum gel is used with a dynamic viscosity at zero velocity gradient comprised between 7 and 1680 mPa·s, preferably 135 mPa·s.

Preferably, konjac gum is used at a concentration comprised between 0.5 and 10 g/L, preferably 4 g/L.

Preferably, a konjac gum gel is used with a dynamic viscosity at zero velocity gradient comprised between 1 and 450 mPa·s, preferably 27 mPa·s.

### The Enzymes

The composition according to the invention can further comprise an enzyme capable of degrading said gel prepared from one or more thickening and/or gelling agents and an aqueous solution at a concentration allowing a total degradation of said gel in less than 12 hours, preferably in less than 6 hours, more preferably in less than 2 hours.

The addition of the enzyme to the composition improves the rate of release from the gel of living biocontrol agents of the phytoseiidae family of the genus Phytoseiulus after dispersion or spraying of the composition.

The rate of release of a composition according to the invention with enzyme is preferably greater than 80%.

The enzyme is preferably added last to the composition according to the invention.

The enzyme is preferably added to the composition according to the invention less than 2 hours before its dispersion/spraying, preferably just before its dispersion/spraying. The enzyme is of course suitable for degrading said thickening agent/gelling agent of the composition.

The most favourable conditions are obtained when the enzyme degrades the gel rapidly, since the faster the gel is degraded, the faster the biocontrol agents are released.

A person skilled in the art will know which concentration of the enzyme to choose as a function of its enzymatic activity, the optimum temperature, concentrations of thickening agent and the desired hydrolysis time.

The concentration of the enzyme is preferably chosen in order to degrade 100% of the gel in less than 12 hours, preferably in less than 6 hours, more preferably in less than 2 hours, particularly preferably in less than 1 minute.

For example, enzymes will be used:
for hydrolysing the glycosidic bonds for the family of saccharides/polysaccharides.

In the case of alginate, alginate lyase degrades the alginate by β-elimination of the glycosidic bonds.

In the case of modified corn starch, alpha-amylase hydrolyses the alpha (1,4) glycosidic bonds. For example, alpha-amylase is used with an enzyme activity of 800 FAU/g at 20° C., 1 FAU hydrolysing 17 mg of starch per minute. In order to degrade 100 mL of modified corn starch at 34 g/L in 1 minute, 200 FAU are required, i.e. 0.25 g of alpha-amylase. For a degradation in two hours, 1.6 FAU, i.e. 0.002 g of alpha-amylase, is required. Finally, for a degradation in 12 hours, 0.27 FAU i.e. 0.3 mg of alpha-amylase is required.

In the case of amylopectin, the alpha-amylase hydrolyses the (1,4) alpha glycosidic bonds.

In the case of dextrins, glycose hydrolase limits dextrinase which hydrolyses the (1,6) alpha glycosidic bonds.

In the case of carrageenans, it is k-carragheenase which hydrolyses the (1,4) alpha glycosidic bonds.

In the case of guar gum and xanthan gum, it is beta-mannanase which randomly hydrolyses the (1,4)-β-D-mannosidic bonds. For xathan gum, xanthan lyase hydrolyses the beta-D-mannosyl-beta-D-1,4-glucuronosyl bonds.

in the case of chitosan, it is chitosanase which hydrolyses the beta (1,4) glycosidic bonds between the D-glucosamine residues.

In the case of konjac, endo-1,4 beta-mannanase hydrolyses the (1,4) beta glycosidic bonds of the glucomannan residues.
For the cellulose derivatives:
Endocellulase: breaks the crystalline structure of the cellulose into polysaccharide chains.
Exocellulase: cuts 2-4 units at the ends of the polysaccharide chains.
β-glucosidase: hydrolyses the polysaccharide chains into monosaccharides.
Oxidative cellulase: depolymerises cellulose.
Cellulose phosphorylase: depolymerises cellulose using phosphates.

### Method for Preparing the Composition

The method for preparing the composition according to the invention comprises the following steps:
dissolving one or more thickening and/or gelling agents in an aqueous base, preferably water, until a gel is formed;
adding biocontrol agents of the phytoseiidae family of the genus Phytoseiulus and dispersing them homogeneously in said gel;
optionally, adding an enzyme capable of degrading said gel at a concentration allowing the total degradation of said gel in less than 12 hours, preferably in less than 2 hours.

This preparation method is preferably carried out at between 18° C. and 25° C., particularly preferably at 20° C.

This preparation method is preferably carried out at a relative humidity greater than 30%, preferably 60%.

### The Method for Dispersing the Composition

The compositions according to the invention are preferably applied on plants by spraying.

In order to spray this solution without injuring or killing the mites, the pressure used must be low and the nozzles must not have parts able to harm them. For example, a low-pressure sprayer solution such as a paint gun can be used. The liquid is entrained by the passage of air and cannot in any way injure the mites.

### Uses

The composition according to the invention can be used to improve the efficiency of biological control methods.

The compositions according to the invention are suitable for being dispersed on crops chosen among fruit trees, vines, vegetable crops, field crops, sheltered crops and ornamental crops. The compositions according to the invention are suitable for biologically combating species of mite of the genus Tetranychus, in particular Tetranychus urticae.

### FIGURES

FIG. 1A: The effect of a modified corn starch gel at 34 g/L on the fertility of Phytoseiulus persimilis without spraying±alpha-amylase A.=repetition 1

FIG. 1B: The effect of a modified corn starch gel at 34 g/L on the fertility of Phytoseiulus persimilis without spraying±alpha-amylase B.=repetition 2

FIG. 2: The effect of a modified corn starch gel at 34 g/L on the fertility of Phytoseiulus persimilis with spraying±alpha-amylase

FIG. 3: Study of the homogeneous distribution of Phytoseiulus persimilis

### EXAMPLES

### Example 1: Studies of the Effects of a Modified Corn Starch Gel on the Biological Characteristics of Phytoseiulus Persimilis

### Materials and Methods

Experimental conditions: 25° C. and 75% RH, photoperiod 16/8
Study of the fertility and longevity: n=33 individuals per procedure, 2 repetitions Study of the percentage release of mites from the device: n=100 individuals per procedure, 4 repetitions
Study of the homogeneous distribution of Phytoseiulus persimilis in the composition:
Repetition=1, Replicas=2 over time t=0 (just after the distribution) and t=30 minutes, 5 fractions with 590 persimilis counted per replica. The Phytoseiulus persimilis are distributed in the gel 30 minutes after producing the gel.
Thickening agent=modified corn starch
Concentration of thickening agent: 34 g/L
Enzyme=alpha-amylase of Aspergillus oryzae, ≥800 FAU/g
Concentration of the enzyme: 480 μL/L

### Results

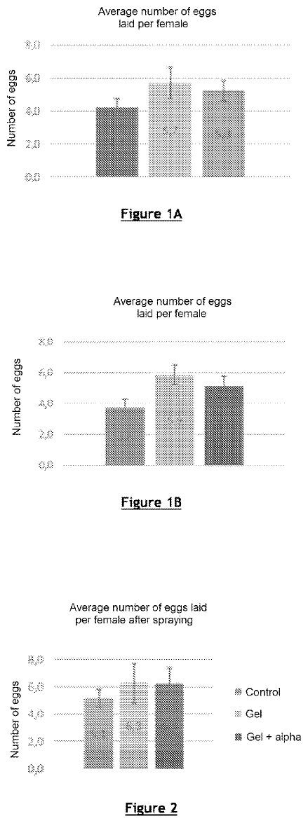

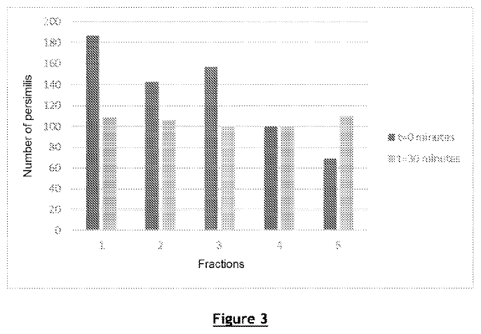

The results are described in FIGS. 1, 2 and 3 and in table 1 below.

No significant difference is observed whatever the conditions, on the fertility of the mites and on the longevity of the female mites.

The distribution is homogeneous.

TABLE 1
Effect of the solution on the longevity of Phytoseiulus persimilis
with or without spraying

| | | Females alive |
|---|---|---|
| Repetition | Procedure | at 5 days |
| 1 (without | Control | 80% |
| spraying) | Modified corn starch | 84% |
| | Modified corn starch + | 86% |
| | alpha-amylase | |
| 2 (without | Control | 77% |
| spraying) | Modified corn starch | 85% |
| | Modified corn starch + | 82% |
| | alpha-amylase | |
| 1 (after | Control | 78% |
| spraying) | Modified corn starch | 77% |
| | Modified corn starch + | 80% |
| | alpha-amylase | |

### Example 2: Survival Test of Phytoseiulus persimilis in Various Thickening Agents

### Materials and Methods:

18 thickening agents authorised for food-use were selected:

| Polysaccharides | Polyacrylate | Derivatives of | Derivatives of | Metal |
|---|---|---|---|---|
| and saccharides | salts | Povidone | Cellulose | salts |
| Alginate | Carbomer | PVP: Polyvinyl- | Carboxymethyl- | Calcium |
| | 940 | pyrrolidone | cellulose | chloride |
| Modified corn | Gel Maker | | Hydroxypropyl- | Potassium |
| starch | EMU | | cellulose | chloride |
| Amylopectin | | | | Aluminium |
| | | | | sulfate |
| Carrageenans | | | | |
| Chitosan | | | | |
| Dextrin | | | | |
| Guar gum | | | | |
| Xanthan gum | | | | |
| Glycerol | | | | |
| Konjac | | | | |

The concentrations tested were:

| | Minimum | Concentration | Maximum |
|---|---|---|---|
| Thickening agents | concentration (g/L) | tested (g/L) | concentration (g/L) |
| Alginate | 1 | 10 | 20 |
| Modified corn starch | 30 | 34 | 90 |
| Amylopectin | 25 | 67 | 120 |
| Carrageenans | 1 | 3 | 10 |
| Chitosan | 50 | 100 | 300 |
| Dextrin | 10 | 46 | 100 |
| Guar gum | 0.5 | 2 | 5 |
| Xanthan gum | 0.5 | 2 | 5 |
| Glycerol | 500 | 860 | 1000 |
| Konjac | 0.5 | 4 | 10 |
| Carbomer 940 | 0.5 | 4 | 10 |
| Gel Maker EMU | 0.5 | 4.4 | 10 |
| PVP: Polyvinyl | 10 | 60 | 200 |
| pyrrolidone | | | |
| Carboxymethylcellulose | 10 | 30 | 100 |
| Hydroxypropylcellulose | 10 | 30 | 150 |
| Calcium chloride | 200 | 280 | 740 |
| Potassium chloride | 200 | 280 | 330 |
| Aluminium sulfate | 100 | 140 | 350 |

500 persimilis are added to the solutions.

The mixture is rated “homogeneous” if the persimilis distribute homogeneously in the thickening agent with no, or only a few, clumps for more than 20 minutes.

In the case where the persimilis distribute homogeneously, a drop release test is performed. In other words, using an automatic pipette, 2 mL of the solution containing the persimilis is taken and distributed in the form of drops (30 drops on a sheet of A4 paper).

A little solution containing the persimilis is kept in order to evaluate any possible “toxicity” at 12 hours.

The total number of individuals present in the drops after deposition is counted. Then the persimilis that are counted after complete drying of the drops at 25° C. and 75% RH are released.

The results will allow us to obtain a rate of release of individuals.

### Results:

| | | | | | | Release | Release | Release | Release |
|---|---|---|---|---|---|---|---|---|---|
| | | | | | | rate of | rate of | rate | rate |
| | | | | Homogeneous | | drops | drops | after | after |
| | | | Equivalent | persimilis | | without | with | spraying | spraying |
| | | Concentration | to the | mixture > 20 | | enzyme | enzyme | without | with |
| Family | Name | tested (g/L) | standard | min | “Toxicity” | (%) | (%) | enzyme | enzyme |
| Polysaccharides | Alginate | 10 | Yes | Yes | Yes | 61 | | | |
| and saccharides | Modified corn starch | 34 | Yes | Yes | No | 52 | 94 | 31 | 94 |
| | Amylopectin | 67 | No | | | | | | |
| | Carrageenans | 3 | Yes | Yes | No | 65 | | 60 | |
| | Chitosan | 100 | No | | | | | | |
| | Dextrin | 46 | No | | | | | | |
| | Guar gum | 2 | Yes | No | No | | | | |
| | Xanthan gum | 2 | Yes | Yes | No | 78 | | 68 | |
| | Glycerol | 860 | Yes | No | Yes | | | | |
| | Konjac | 4 | Yes | Yes | No | 61 | | 66 | |
| Polyacrylate | Carbomer 940 | 4 | Yes | No | No | | | | |
| salts | Gel Maker EMU | 4.4 | Yes | Yes | Yes | 79 | | | |
| Derivatives of | PVP | 60 | Yes | No | No | 72 | | 67 | |
| Povidone | | | | | | | | | |
| Derivatives of | Carboxymethylcellulose | 30 | yes | No | No | | | | |
| Cellulose | Hydroxypropylcellulose | 30 | No | | | | | | |
| Metal salts | Calcium chloride | 280 | No | | | | | | |
| | Potassium chloride | 280 | No | | | | | | |
| | Potassium sulfate | 140 | no | | | | | | |

The 4 thickening agents meeting the most criteria are: modified corn starch; carrageenans; xanthan gum and konjac gum. (In grey in the table)

For example: in the case of modified corn starch, there is a change from 31% release without enzyme to 94% release with enzyme (alpha-amylase).

For example: For modified corn starch, there is a change from 52% release to 94% release with enzyme tested in drops.

### Example 3: Viscosity Measurement of Various Thickening Agents

The viscosities are measured at 22° C. with a rotational viscometer (ROTAVISC of brand IKA) and at an observed speed of rotation comprised between 3 rpm and 15 rpm (the apparatus adjusts the speed in order to have stable data).

| Thickening agents | Concentration (g/L) | Viscosity (mPa · s) |
|---|---|---|
| Alginate | 1 | 13 |
| | 10 | 235 |
| | 20 | 5945 |
| Modified corn starch | 30 | 60 |
| | 34 | 80 |
| | 90 | 25100 |
| Carrageenans | 1 | 1 |
| | 3 | 2 |
| | 10 | 4900 |
| Guar gum | 0.5 | 1 |
| | 2 | 10 |
| | 5 | 431 |
| Xanthan gum | 0.5 | 7 |
| | 2 | 135 |
| | 5 | 1680 |
| Glycerol | 500 | 36 |
| | 860 | 90 |
| | 1000 | 740 |
| Konjac | 0.5 | 1 |
| | 4 | 27 |
| | 10 | 450 |
| Carbomer 940 | 0.5 | 1 |
| | 4 | 6 |
| | 10 | 17 |
| Gel Maker EMU | 0.5 | 1 |
| | 4.4 | 10 |
| | 10 | 258 |
| PVP: Polyvinyl | 10 | 6 |
| pyrrolidone | 60 | 133 |
| | 200 | 3024 |
| Carboxymethylcellulose | 10 | 1 |
| | 30 | 6 |
| | 100 | 1280 |

1. Sprayable aqueous composition for spreading biocontrol agents, comprising live biocontrol agents from the phytoseiidae family of the genus Phytoseiulus which are homogenously dispersed in a gel prepared from one or more thickening and/or gelling agents and an aqueous solution, said thickening and/or gelling agents being non-toxic for the biocontrol agents and said gel having a dynamic viscosity at zero velocity gradient between 1 and 30,000 mPa·s.

2. The composition according to claim 1, wherein said thickening and/or gelling agents are selected from the group consisting of polysaccharides and saccharides.

3. The composition according to claim 2, wherein said polysaccharides and saccharides are selected from the group consisting of modified corn starch, carrageenans, xanthan gum and konjac gum.

4. The composition according to claim 1, wherein said biocontrol agents of the phytoseiidae family of the genus Phytoseiulus are selected from the group consisting of Phytoseiulus persimilis, Phytoseiulus macropilis, Phytoseiulus longipes and Phytoseiulus fragariae.

5. The composition according to claim 1, wherein the rate of release from the gel of living biocontrol agents of the phytoseiidae family of the genus Phytoseiulus is greater than 60%.

6. The composition according to claim 1, further comprising an enzyme capable of degrading said gel prepared from one or more thickening and/or gelling agents and an aqueous solution at a concentration allowing a total degradation of said gel in less than 12 hours.

7. The composition according to claim 6, wherein said enzyme is alpha-amylase and said thickening agent/gelling agent is modified corn starch.

8. The composition according to claim 1, wherein said one or more thickening and/or gelling agents is present in a quantity between 0.5 and 200 g/L.

9. A method for preparing a composition according to claim 1, comprising the successive steps of:
dissolving one or more thickening and/or gelling agents in an aqueous base, until a gel is formed,
adding biocontrol agents of the phytoseiidae family of the genus Phytoseiulus and dispersing them homogeneously in said gel,
optionally, adding an enzyme capable of degrading said gel at a concentration allowing the total degradation of said gel in less than 12 hours.

10. (canceled)

11. A method of biological control comprising a step of applying, on plants, a composition according to one claim 1.

12. The method according to claim 11, wherein the application of a composition according to claim 1 is carried out by spraying.

13. The composition according to claim 1, further comprising an enzyme capable of degrading said gel prepared from one or more thickening and/or gelling agents and an aqueous solution at a concentration allowing a total degradation of said gel in less than 2 hours.

14. A method according to claim 9 wherein the aqueous base is water.
